(19) United States
(12) Patent Application Publication
(10) Pub. No.: US 2007/0202243 A1
(43) Pub. Date: Aug. 30, 2007

(54) Organoleptically Improved, In Particular, Storage Stable Hard Candy

(75) Inventors: Margit Arenz, Nehren (DE); Jorg Bernard, Albsheim (DE)

Correspondence Address: HARNESS, DICKEY & PIERCE, P.L.C., P.O. BOX 828, BLOOMFIELD HILLS, MI, 48303, US

(73) Assignee: SUDZUCKER AKTIENGESELLSCHAFT MANNHEIM/OCHSENFURT, MANNHEIM (DE)

(21) Appl. No.: 11/659,902

(22) PCT Filed: Aug. 5, 2005
(86) PCT No.: PCT/EP05/08483

§ 371 Date: Feb. 8, 2007

(30) Foreign Application Priority Data
Aug. 10, 2004 (DE) 10 2004 038 689.7

(51) Int. Cl. A23G 3/00

(52) U.S. Cl. 426/660

(57) ABSTRACT

The present invention relates to hard candies having improved storage characteristics as well an improved sensory profile and method for their manufacture.

The present invention relates to hard candies and hard candy masses, containing 61.0 to 70.0% by weight in the dry material (DM) 1-O-α-D glucopyranosyl-D-mannite (called 1,1 GPM in what follows), 2.5 to 17.0% by weight in the dry material (DM) maltite and a sorbite content determined in correlation to the 1,1 GPM and maltite content and a method for production of same.

EP-A2 0 303 295 describes a hard candy which contains mesoerythrite as the principal component as well as additional saccharides such as sucrose, glucose, malt syrup, fructose, isomaltulose and isomaltose. U.S. Pat. No. 4,587,119 describes the use of isomaltulose as a sucrose substitute in specific foods and pharmaceutical products. U.S. Pat. No. 4,971,798 discloses hard candies which contain hydrogenated isomaltulose. Hydrogenated isomaltulose is an almost equimolar mixture of 6-O-α-D-glucopyranosyl-D-sorbite (called 1,6 GPS in what follows) and the stereoisomeric 1,1 GPM. This mixture is also designated as palatinate and in what follows as isomalt. Isomalt is produced by enzymatically isomerizing sucrose, separating the resulting isomaltulose from the additional ingredients, for example trehalulose and isomaltose, and hydrogenating the isomaltulose in 1,6 GPS and 1,1 GPM, wherein 1,1 GPM crystallizes out as a dihydrate. In EP 0 625 578 B1, hard candies are mentioned which contain a sweetener mixture of 1,1-GPS (1-O-α-D-glucopyranosyl-D-sorbite), 1,1 GPM and 1,6 GPS. It is explained that increasing the 1,1-GPS content suppresses the tendency of 1,1-GPS to crystallize. Hard candies are not disclosed in this publication. DE 195 32 396 C2 discloses hard candies which contain a 1,6 GPS or 1,1 GPM enriched mixture. A 1,1 GPM-enriched mixture is understood to mean a mixture of 1,6 GPS and 1,1 GPM which has a ratio of 1% by weight: 99% by weight to <43% by weight: >57% weight 1,6 GPS to 1,1 GPM, meaning >57% to 99% weight 1,1 GPM. The hard candies specifically disclosed in this publication have a 1,1 GPM content of 85% by weight. The distinguishing feature of the hard candies described is, however, that especially under extended storage, they tend to recrystallize, when crystallized areas form on the surface of the hard candies or clouding appears thereon. Both phenomena are undesirable since they can affect saleability as well as the taste sensation.

EP 0 533 334 describes a method for producing hard candies in which they have a sugar alcohol mixture with a maltite content of more than 77% by weight but less than 86% by weight. It is explained that a maltite content of less than 77% by weight leads to hygroscopic and sticky hard candies, while a maltite content of more than 86% by weight leads to opaque clouding of the hard candies as the result of maltite crystallization. EP 0 611 527 also describes the crystallization of maltite in hard candies in which a maltite syrup having a maltitol content of more than 78% by weight is used, since syrups with a low maltite content deliver unsatisfactory results with respect to hygroscopicity, cariogenicity and the technical aspects of their application. EP 1 194 042 B1 discloses a syrup for manufacturing hard candies in which it has 7 to 52% by weight 1,6-GPS, 24.5 to 53% by weight 1,1 GPM, 2.8 to 13.8% by weight maltite and 0 to 1.3% weight sorbite. The resulting hard candies prove to be in need of improvement from an organoleptic perspective, in particular while they are being consumed.

EP 1 217 898 B1 discloses hard candies with a 1,1 GPM content of 52 to 60% by weight and a sorbite content of 0.5 to 3.5%. These hard candies are distinguished particularly by improved storage stability. However, the disadvantage is that in the matter of the long storage stability desired by customers, which was ensured in the aforementioned hard candies by setting a specific 1,1 GPM content, specifically the surface of the hard candies is rough and is not experienced as attractive by consumers. Hard candies with a rough surface are experienced by customers as just as unattractive in taste as hard candies which have a surface experienced as excessively smooth, in some instances even greasy. There exists a need now as before for hard candies which, with the longest possible storage stability even under unfavorable climatic conditions, for example high humidity and high ambient temperatures, are experienced by customers as attractive to the taste, meaning specifically no or only minor crystallization of the ingredients occurs, only minor roughness or preferably no roughness at all can be felt on the surface and at the same time no sensation of greasiness is conveyed to the consumer. The observation that hard candies which contain 1,1 GPM, as they dissolve in the mouth, meaning while they are being consumed, tend to a feeling of creation or formation of roughness, probably because of recrystallization of the 1,1 GPM proves unattractive to consumers.

The technical problem underlying the present invention is therefore to prepare hard candies which, with improved storage stability and at least equivalent or improved sensory attractiveness, or alternatively with equivalent storage stability, induce an improved organoleptic sensation in the consumer, also and specifically while it is being consumed.

The solution to this technical problem is achieved by providing a hard candy and a hard candy mass which contains a 1,1 GPM content of 61 to 70% by weight (% by weight figures according to the current teaching are always referenced to total dry material of the hard candy or hard candy mass, unless stated otherwise), a maltite content of 2.5 to 17% by weight and a sorbite concentration (in what follows also designated as [S] or [sorbite]), which is determined in exact calibration of, meaning as a function of, the 1,1 GPM and maltite content adjusted in the previously named limits. The sorbite concentration is calculated as a function of the adjusted 1,1 GPM and maltite content in the hard candy in accordance with the invention or in the hard candy mass using the equation
[sorbite]=c+b×[1,1 GPM]+a×[1,1 GPM]×[maltite]

where a=0.0016 to 0.0005

b=0.0139 to 0.0019, specifically −0.0004 to 0.0019, and

c=0.9 to −0.19, specifically 0.9 to 0.2 and

where concentration figures [ ] in g/100 g total dry material result and × means multiplication.

The invention therefore presents the technical teaching that a hard candy that is particularly storage-stable and sensorially particularly attractive can be prepared if the hard candy has a 1,1 GPM and a maltite content which is within the aforementioned ranges and which has a sorbite content which follows the previous formula. The invention enriches the prior art by having demonstrated a correlation between the contents of sorbite, 1,1 GPM and maltite which results in especially advantageous hard candies and hard candy masses. The aforementioned equation allows the person skilled in the art, for example at a given GPM and maltite content, to adjust the sorbite content without difficulty such that an advantageous hard candy and hard candy mass can be prepared. Conversely, for example in the presence of a raw material with a concrete sorbite and maltite content, the 1,1 GPM content can be adjusted without difficulty such that a hard candy and hard candy mass in accordance with the invention is prepared. Finally, the invention makes it possible, with a specified sorbite and 1,1 GPM content, to adjust the maltite content such that an advantageous hard candy or hard candy mass is obtained.

The provision of the invention is for the hard candy or hard candy mass in accordance with the invention to contain 1,1 GPM in an amount of 61.0 to 70.0% by weight and maltite in an amount of 2.5 to 17.0% by weight, preferably from 5.0 to 16.0% by weight and sorbite in a concentration [S] calculated in accordance with the equation.

The invention also solves its fundamental technical problem by providing a hard candy and a hard candy mass which contain a 1,1 GPM content of 61 to 70% by weight, preferably 62 to 68% by weight, a maltite content of 2.5 to 17% by weight, preferably 2.5 to 16% by weight, especially preferably 5 to 16% by weight and a sorbite content of 0.1 to 1.6% by weight, preferably 0.2 to 1.55% by weight, especially preferably 0.4 to 10.0% by weight.

In a preferred embodiment, provision can be made to adjust the malite and sorbite content named by using a maltite syrup, for example Lycasin, with the corresponding maltite and sorbite content.

The hard candies in accordance with the invention are surprisingly distinguished in the matter of organoleptics experienced as attractive by the consumer by a considerably reduced tendency to recrystallization than known hard candies, specifically than hard candies made from isomalt. Their storage stability is considerably improved, particularly compared with isomalt hard candies. The formation of crystalline areas on the surface of the hard candies as well as opaque zones inside the hard candies is largely or entirely prevented under the invention, or it does not occur until considerably later. Hard candies in accordance with the invention are additionally distinguished, particularly while melting in the mouth, meaning during consumption, by a sensory feeling experienced as very pleasant, where this occurs only in the present combination of concrete contents of 1,1 GPM, sorbite and malite. An observed formation of roughness with conventional hard candies containing 1,1 GPM, in particular hard candies having high contents, for example of 1,1 GPM content above 70% by weight, is avoided. Compared with hard candies having high contents of 1,1 GPM, the hard candies in accordance with the invention are specifically characterized by an improved taste sensation along with at least equivalent storage stability.

In conjunction with the present invention, hard candy is understood to be an amorphous product which can be produced by extracting water by evaporation from an aqueous solution or suspension of a sweetening agent, for example a sugar substitute, so that the solution or suspension of the sugar substitute is concentrated and bringing this concentrate into any given form, for example pouring or molding. Hard candies can also be produced by melt extrusion of a dry sweetening agent mixture. Naturally, additional ingredients such as aromas, dyes, intense sweeteners or similar may be added to the hard candy during production, which, as long as it does not contain any additional additives besides bulking sugar or sweetener, may also be designated as vitreous body or hard candy mass.

In conjunction with the present invention, the term “sweetening agent” is understood to mean substances which have sweetening power and are added, for example, to foods or beverages to invoke a taste of sweetness. In conjunction with the present invention the “sweetening agents” are divided into “sugars” such as sucrose, glucose or fructose and “sweetening agents”, materials that are not sugars but still have sweetening power, where the latter are further subdivided into “sugar substitutes”, sweetening agents that have bulk and a physiological caloric value in addition to sweetness (bulking sweetening agent), and “intense sweeteners”, materials which usually have very high sweetening power, but no bulk and usually do not have any or only a very small physiological caloric value. Sugar substitutes are usually sugar alcohols.

Storage stability was determined as part of the present invention by storing the hard candies open for three days at 25° C. and 80% relative humidity. Seventy two hours after the commencement of storage, the hard candies were subjected to an organoleptic evaluation, in which firstly the extent of visually perceptible recrystallization and secondly the stickiness of the hard candy was analyzed. Improved storage stability as part of the present invention exists specifically when comparable candies are evaluated as worse with respect to the visually perceptible recrystallization and/or stickiness, particularly when the hard candies in accordance with the invention show a lesser degree of visually perceptible recrystallization and/or a lesser degree of stickiness.

The sensory properties of the hard candies in accordance with the invention were evaluated as part of the present invention specifically using freshly produced hard candies, where the hard candies were evaluated by at least 5 independent testers and classified on a sensory taste scale with the grades 1 (smooth) to 3 (rough). Improved taste sensation is present specifically when the hard candies have a lesser degree of roughness and/or a lesser degree of greasiness as opposed to comparable candies, where roughness is both an initial roughness that a hard candy has prior to consumption as well as a roughness forming while it is being consumed in the mouth.

In a particularly preferred embodiment of the present invention, provision is made for hard candies or a hard candy mass which have a 1,1 GPM content of 62 to 68% by weight. In a further preferred embodiment the intention is that with a maltite content of 2.5 to 17.0% by weight and a 1,1 GPM content of 61.0 to 70.0% by weight, preferably 62.0 to 68.0% by weight, the sorbite content is 0.1 to 1.6% by weight, having regard to the previous formula. In a further preferred embodiment, the intention is that the sorbite content at a maltite content of 2.5 to 17.0% by weight and a 1,1 GPM content of 61.0 to 70.0% by weight , preferably 62.0 to 68.0% by weight, having regard to the formula previously quoted, is 0.2 to 1.55% by weight, preferably 0.2 to 1.0% by weight.

In a further preferred embodiment, the intention is that at a maltite content of 2.5 to 17% by weight and a 1,1 GPM content of 61 to 70% by weight, preferably 62 to 68% by weight, the sorbite content is 0.1 to 1.6% by weight, preferably 0.1 to 0.9% by weight.

In a further preferred embodiment, the intention is that at a maltite content of 2.5 to 17% by weight and a 1,1 GPM content of 61.0 to 70% by weight, preferably 62.0 to 68.0% by weight, the sorbite content is 0.2 to 1.55% by weight, preferably 0.4 to 1.0% by weight, specifically 0.4 to 0.9% by weight.

In a particular embodiment of the present invention, the hard candy or hard candy mass respectively in accordance with the invention has maltite, sorbite and 1,1 GPM as the single and only sugar substitutes present and/or as the single and only sugar alcohols present. In a further preferred embodiment of the present invention, the hard candy or hard candy mass respectively in accordance with the invention has maltite, sorbite, 1,1 GPM and 1,6 GPS as the single and only sugar alcohols or sugar substitutes present. In a further preferred embodiment, the hard candy or hard candy mass in accordance with the invention has maltite, sorbite and 1,1 GPM as the single and only bulking sweetening agent present, specifically as the single and only sweetening agent present. In a further preferred embodiment, the present hard candy or hard candy mass in accordance with the invention has maltite, sorbite, 1,1 GPM and 1,6 GPS as the single and only bulking agent present, preferably as the single and only sweetening agent present. In an especially preferred embodiment, the present hard candy or hard candy mass in accordance with the invention is sugar-free, and/or acariogenic and/or reduced in caloric value and/or calorie-reduced. In a further embodiment, the hard candy or hard candy mass in accordance with the invention is free of intense sweeteners.

The hard candy can, if desired, contain further excipients or additives, such as additional sweeteners, for example sugar alcohols, sugar substitutes or intense sweeteners, dyes, flavor additives, flavors, food-compatible acids, preservatives, mineral salts, active ingredients, fillers, fats, fat substitutes, containing for example Ca²⁺, NaCl, trinatriumcitrate, phosphate or Mg²⁺ or binders. So the hard candy in accordance with the invention can contain sugar alcohols, specifically 1,6 GPS, 1,1 GPS, hydrogenated and/or non-hydrogenated starch hydrolysate (HSH), erythrite, xylite, maltotriose, lactite, maltodextrine and/or mannite. Maltotriose can be present in a preferred embodiment in a content from 0 to 8% by weight, preferably 3 to 8% by weight. Mannite can be used in a preferred way in a volume from 0.4 to 4% by weight. In accordance with the invention, a medicinally active material can be added as an active ingredient which develops prophylactic or therapeutic effects on the human or animal body, for example antihistamines, antibiotics, fungicides, microbicides, hexylresorcin, dextromethorphan-hydrobromide, menthol, nicotine, caffeine, vitamins, zinc, eucalyptus, benzocain, cetylpyridinium, fluorides, phenylpropanolamine or other pharmaceutically effective substances.

The hard candies in accordance with the invention can contain flavoring substances such as plant and fruit oils, citrus oils, flower or leaf oils, oils from cherry, strawberry, menthol, eucalyptus, peppermint, honey or green mint, fruit essences, green tea extract or natural or synthetic dyes, etc. The flavoring agents mentioned are preferably added in a volume from 0.05 to 3% by weight. The hard candies can in a preferred embodiment of the invention also contain binders such as alginate, cellulose, gelatin or plant gums.

Provision can also be made to add intense sweeteners to the hard candies in accordance with the invention in order to increase the sweetness, such as aspartame, cyclamate, acesulfam-K, saccharine, sucralose, glycyrrhizine, monelline, dulcine, naringine, dihydrochalcone, neotame, alitame, neohesperidine DC (dihydro chalcone), stevioside, thaumatine or similar.

In accordance with the invention, synthetic or natural dyes can be considered as artificial coloring. For example, erythrosine, indigo carmine, allura red, E171, tartazine, titanium oxide or similar can be used as a synthetic coloring. Natural dyes can be carotinoids, for example betacarotine, riboflavine, chlorophyll, anthocyane, for example from red beetroot, betanine or similar. In the event that synthetic dyes are used, typically 0.01 to 0.03% by weight coloring is used, while preferably 0.1 to 1% by weight natural coloring are used.

Polydextrose or inulin, for example, can serve as fillers. Caprenin, salatrim or olestra are examples of possible fat substitutes. Plant fats, for example unhardened fats or milk fats, can be used as fats.

Citric acid, malic acid, lactic acid, tartaric acid, ascorbic acid or food compatible acids with similar effects can be used.

The hard candies in accordance with the invention can also contain a milk product, for example a dairy product such as a full milk powder or cream. Such milk products can preferably be present in a volume from 0 to 9% by weight.

The hard candies in accordance with the invention can also contain emulgators, such as lecithin, for example soy lecithin or similar, for example up to an amount of 0 to 5% by weight.

The invention therefore envisions a hard candy which contains 1,1 GPM, sorbite and mannite as well as one or more sugar alcohols selected from the group consisting of 1,6 GPS, 1,1 GPS, higher polyols and maltotriose in the amounts in accordance with the invention and additionally 1 to 10% by weight of additional materials selected from the group consisting of intense sweeteners, fillers, flavors or aroma substances, colorings, medicinally effective ingredients, food-compatible acids, fat substitutes, fat, dairy products and/or mineral salts and/or emulgators.

Naturally, the hard candy or hard candy mass as described in accordance with the invention can also contain additional sugar alcohols, such as 1,6 GPS and/or 1,1 GPS. In a preferred embodiment, the hard candy in accordance with the invention, in addition to the stated quantities of 1,1 GPM, maltite and sorbite, at least one additional sweetening agent, preferably 1,6 GPS, specifically 5 to 36.4% by weight, preferably 11.4 to 36.4% by weight 1,6 GPS, where provision can preferably be made, in its stead, to incorporate into the hard candy preferably a small amount of 1,6 GPS, for example an amount of 1 to 8% by weight, maltotriose, higher polyols, 1,1 GPS, aroma substances, mannite, food-compatible acids and/or fats, or milk products. Provision can also be made preferably to prepare a hard candy which contains 61 to 70% by weight 1,1 GPM, 2.5 to 17% by weight maltite, 0.1 to 1.6% by weight sorbite and 5.0 to 36.4% by weight of one of more materials selected from the group consisting of maltotriose, 1,6 GPS, 1,1 GPS and higher polyols, for example 1.5 to 2.4% by weight maltotriose and/or 3.0 to 13.5% by weight higher polyols and/or 5 to 26.4% by weight 1,6 GPS. If necessary, additional materials such as aroma substances, food-compatible acids, artificial coloring or/and dairy products and/or emulgators can be present. The hard candy or hard candy mass in accordance with the invention can, as explained, preferably be sugar-free, that is suitable for diabetics, and tooth-friendly. Provision can also be made for sugar, such as sucrose, glucose, fructose or similar to be present in the hard candy.

The invention also relates to a method for producing the hard candies or hard candy mass in accordance with the invention, wherein an aqueous solution or suspension, containing an educt mixture of the aforementioned quantities of 1,1 GPM, maltite and sorbite, for example 61 to 70% by weight 1,1 GPM and 2.5 to 17% by weight maltite, as well as the quantity of sorbite [S] deriving from the formula, is heated to 145 to 170° C. for example, evaporated, cooled and concentrated to a dry material content of at least 95%, 96, 97, 98 or 99.3% by weight. The invention relates also to hard candies or a hard candy mass with a water content of less than 5% by weight, especially less than 4% by weight, preferably below 3% by weight, preferably below 2% by weight or below 0.7% respectively (referred to the total weight of the hard candy). Then the candy is cooled and shaped. The concentration takes place advantageously through evaporation of water by boiling and/or application of vacuum, for example in batches or continuously. The production of the hard candies can also be carried out by melt extrusion.

The invention also relates to a method for producing the hard candies or hard candy mass in accordance with the invention, in which an aqueous solution or suspension, containing an educt mixture of the aforementioned quantities of 1,1 GPM, maltite and sorbite, for example 61 to 70% by weight 1,1 GPM and 2.5 to 17.0% by weight maltite, and 0.1 to 1.6%, specifically 0.1 to 0.9% by weight sorbite is heated, for example, to 145 to 170° C., evaporated, cooled and concentrated to a dry material content of at least 95% by weight, 96, 97, 98, or 99.3% by weight.

The hard candies of the present invention can assume a molded or poured form and, where necessary, contain fillings, for example maltite syrup.

The invention relates therefore to hard candies without filling as well as hard candies with filling, where the filling can assume a solid or liquid form and does not necessarily have to be made from the hard candy mass of the present invention. Instead, provision can be made to configure a hard candy of this kind such that only its coating is produced from the hard candy mass in accordance with the invention, while the filling is constructed from another material, specifically a sugar-free material.

The present invention specifically relates to hard candies consisting of or containing the hard candy mass in accordance with the invention. Thus a filled hard candy can be envisioned the filling of which is of any kind, for example a sugar-free sweetener, and its coating consists of the hard candy mass in accordance with the invention.

The invention relates also to unfilled hard candies consisting of the named hard candy mass in accordance with the invention or containing this hard candy mass with the addition of the named additives.

The invention preferably relates to hard candies, for example, which contain a sweetening agent mixture or bulking agent of maltite, sorbite, 1,1 GPM and, if necessary, 1,6 GPS and/or 1,1 GPS and/or maltotriose and/or higher polyols in the amounts in accordance with the invention in a total amount of 63.6 to 99% by weight, preferably 90 to 99% by weight, an aroma substance or flavoring in an amount of 0.01 to 2.5% by weight, an intense sweetener in an amount of 0.05 to 0.25% by weight, an organic acid in an amount of 0.1 to 5.0% by weight (each referenced to the total weight of the candy), water and, if applicable when used as a medicinally active hard candy, a medicinal active ingredient in an amount of 1.0 to 15 mg per unit, for example. In a further embodiment, a hard candy is prepared which contains a sweetening agent mixture of maltite, sorbite, 1,1 GPM and, if applicable, 1,6 GPS and/or 1,1 GPS and/or maltotriose and/or higher polyols in the amounts in accordance with the invention in a total amount of 63.6 to 99% by weight, preferably 90 to 99% by weight (referenced to the total dry weight of the hard candy), an aroma or flavoring in an amount of 0.01 to 2.5% by weight, an intense sweetener in an amount of 0.05 to 0.25% by weight, an organic acid in an amount of 0.1 to 5.0% by weight, an emulgator in an amount of 0.01 to 2.5% by weight and a dairy product in an amount of 0% by weight, preferably 0.25 to 9% by weight and, if applicable, a medicinal active ingredient in an amount of 1.0 to 15 mg per unit, for example.

Additional advantageous embodiments can be found in the dependent claims.

The invention is explained in more detail using the following examples and the appropriate Figures.

The Figures show:

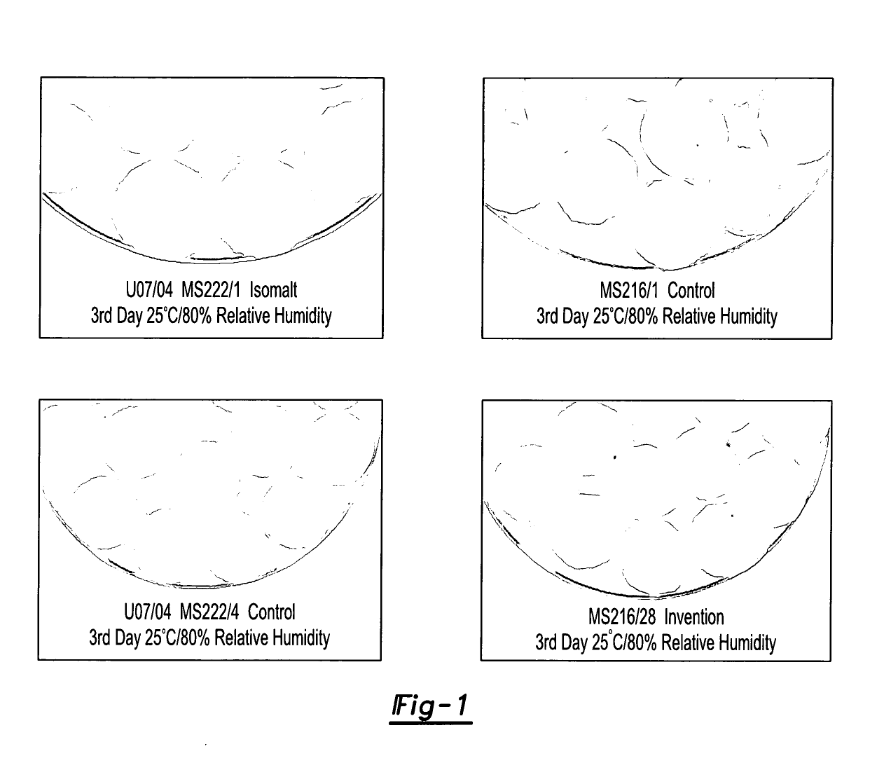

FIGS. 1 to 7 show photographs of hard candies in accordance with the invention and of control hard candies after 3 days storage at 25° C. at 80% relative humidity.

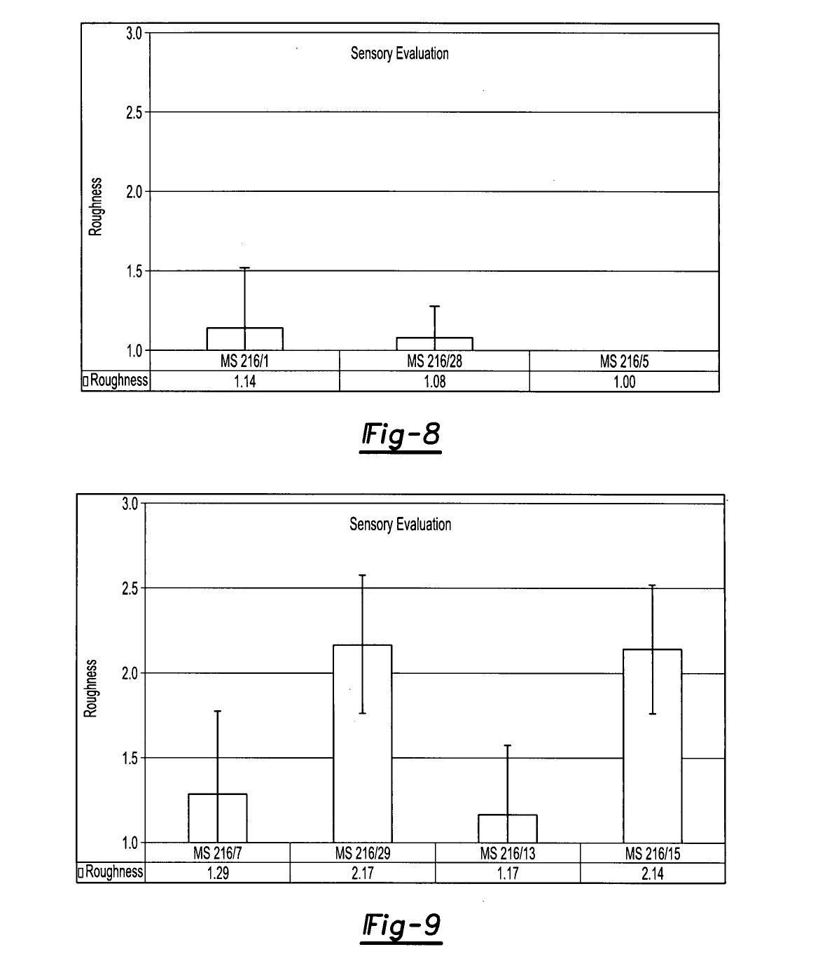

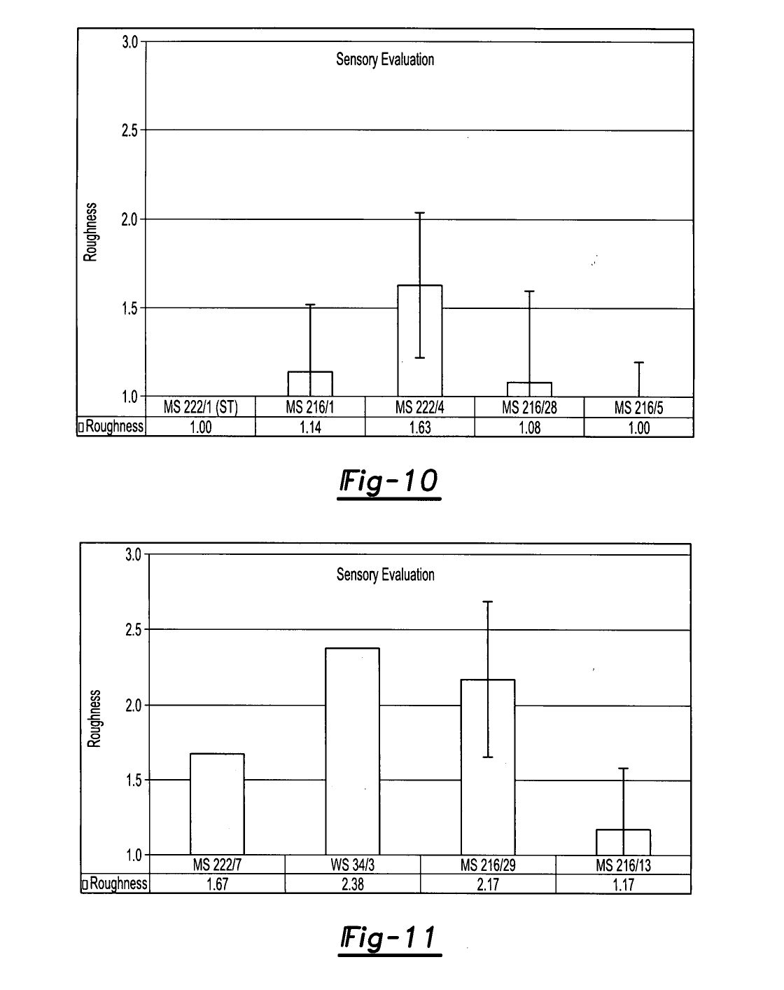

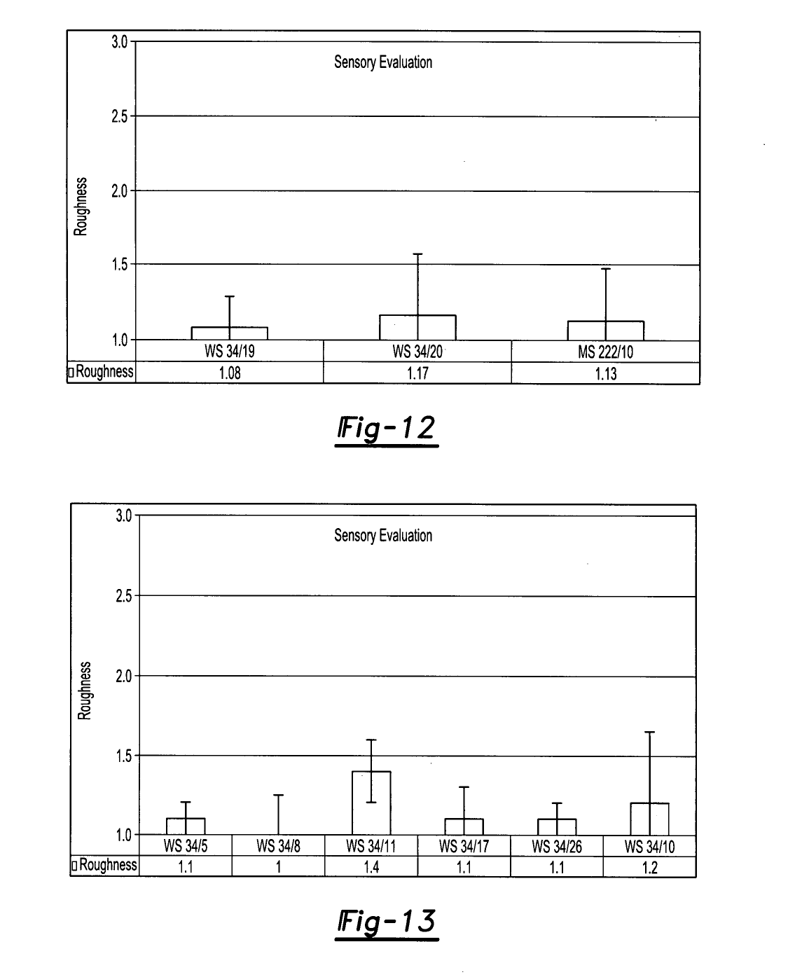

FIGS. 8 to 13 show in graphic form the analysis of the sensory properties of hard candies in accordance with the invention and control candies.

### EXAMPLE 1

### Manufacturing Hard Candies/Vitreous Bodies

The compositions of the hard candies, or vitreous bodies, used can be seen from the following recipes:

A) Detailed Composition

TABLE 1

| | WS34/3 |
|---|---|
| Vitreous body | (Control) |
| Mannite [g/100 g DM] | 0.03 |
| Sorbite [g/100 g DM] | 0.03 |
| Glucosyl glycerol [g/100 g DM] | 0.00 |
| Fructose [g/100 g DM] | 0.00 |
| Glucose [g/100 g DM] | 0.00 |
| Desoxydisaccharide alcohol [g/100 g DM] | 0.02 |
| 1,1 GPS [g/100 g DM] | 0.06 |
| GPI [g/100 g DM] | 0.11 |
| GPM [g/100 g DM] | 84.90 |
| GPS [g/100 g DM] | 13.90 |
| Total additional glucosylglucitols [g/100 g DM] | 0.09 |
| Palatinose [g/100 g DM] | 0.00 |
| 6′-glucosyl-1,1 GPS [g/100 g DM] | 0.00 |
| 6′-glucosyl-1,1 GPM [g/100 g DM] | 0.01 |
| 6′-glucosyl-1,6 GPS [g/100 g DM] | 0.01 |
| 1-glucosyl-1,6 GPS [g/100 g DM] | 0.01 |
| 6-glucosyl-1,1 GPM [g/100 g DM] | 0.04 |
| Total additional DP-3H2 [g/100 g DM] | 0.20 |
| Maltitol [g/100 g DM] | 0.00 |
| Maltotriose [g/100 g TS] | 0.00 |
| Remainder [g/100 g DM] | 0.59 |

TABLE 2

| | WS34/5 |
|---|---|
| Vitreous body | (Control) |
| Mannite [g/100 g DM] | 0.06 |
| Sorbite [g/100 g DM] | 1.79 |
| Desoxydisaccharide alcohol [g/100 g DM] | 0.02 |
| 1,1 GPS [g/100 g DM] | 0.10 |
| GPI [g/100 g DM] | 0.02 |
| GPM [g/100 g DM] | 42.00 |
| GPS [g/100 g DM] | 6.99 |
| Total additional glucosylglucitols [g/100 g DM] | 0.54 |
| 6′-glucosyl-1,1 GPM [g/100 g DM] | 0.02 |
| 6′-glucosyl-1,6 GPS [g/100 g DM] | 0.02 |
| 1-glucosyl-1,6 GPS [g/100 g DM] | 0.02 |
| 6-glucosyl-1,1 GPM [g/100 g DM] | 0.03 |
| Total additional DP-3H2 [g/100 g DM] | 0.22 |
| Maltitol [g/100 g DM] | 26.60 |
| Maltotriose [g/100 g DM] | 10.30 |
| Remainder [g/100 g DM] | 11.27 |

TABLE 3

| | WS34/8 |
|---|---|
| Vitreous body | (Invention) |
| Mannite [g/100 g DM] | 0.17 |
| Sorbite [g/100 g DM] | 1.41 |
| Fructose [g/100 g DM] | 0.02 |
| Glucose [g/100 g DM] | 0.02 |
| Desoxydisaccharide alcohol [g/100 g DM] | 0.02 |
| 1,1 GPS [g/100 g DM] | 0.26 |
| GPI [g/100 g DM] | 0.06 |
| GPM [g/100 g DM] | 61.80 |
| GPS [g/100 g DM] | 6.53 |
| Total additional glucosylglucitols [g/100 g DM] | 0.31 |
| 1-glucosyl-1,6 GPS [g/100 g DM] | 0.02 |
| 6-glucosyl-1,1 GPM [g/100 g DM] | 0.04 |
| Total additional DP-3H2 [g/100 g DM] | 0.02 |
| Maltitol [g/100 g DM] | 16.60 |
| Maltotriose [g/100 g DM] | 6.49 |
| Remainder [g/100 g DM] | 6.23 |

TABLE 4

| | WS 34/10 | |
|---|---|---|
| | (Isomalt | WS34/11 |
| Cream Hard Candy | Control) | (Control) |
| Mannite [g/100 g DM] | 0.04 | 0.05 |
| Sorbite [g/100 g DM] | 0.07 | 0.89 |
| Glucosyl glycerol [g/100 g DM] | 0.01 | 0.01 |
| Glucose [g/100 g DM] | 0.02 | 0.02 |
| Sucrose [g/100 g DM] | 0.00 | 0.00 |
| Desoxydisaccharide alcohol [g/100 g DM] | 0.05 | 0.05 |
| 1,1 GPS [g/100 g DM] | 0.21 | 0.15 |
| GPI [g/100 g DM] | 0.07 | 0.06 |
| GPM [g/100 g DM] | 43.10 | 29.80 |
| GPS [g/100 g DM] | 46.70 | 32.30 |
| Total additional glucosylglucitols [g/100 g DM] | 0.54 | 0.79 |
| Isomelezitose [g/100 g DM] | 0.00 | 0.06 |
| 6′-glucosyl-1,1 GPM [g/100 g DM] | 0.02 | 0.01 |
| 6′-glucosyl-1,6 GPS [g/100 g DM] | 0.02 | 0.02 |
| 1-glucosyl-1,6 GPS [g/100 g DM] | 0.08 | 0.06 |
| 6-glucosyl-1,1 GPM [g/100 g DM] | 0.07 | 0.07 |
| Total additional DP-3H2 [g/100 g DM] | 0.45 | 0.56 |
| Maltitol [g/100 g DM] | 0.05 | 15.00 |
| Maltotriose [g/100 g DM] | 0.02 | 5.76 |
| Remainder [g/100 g DM] | 8.48 | 14.34 |

TABLE 5

| | WS34/17 |
|---|---|
| Cream Hard Candy | (Invention) |
| Mannite [g/100 g DM] | 0.15 |
| Sorbite [g/100 g DM] | 1.15 |
| Glucose [g/100 g DM] | 0.02 |
| Sucrose [g/100 g DM] | 0.02 |
| Desoxydisaccharide alcohol [g/100 g DM] | 0.02 |
| 1,1 GPS [g/100 g DM] | 0.24 |
| GPI [g/100 g DM] | 0.07 |
| GPM [g/100 g DM] | 61.00 |
| GPS [g/100 g DM] | 5.93 |
| Total additional glucosylglucitols [g/100 g DM] | 0.69 |
| Isomelezitose [g/100 g DM] | 0.09 |
| Maltitol [g/100 g DM] | 14.60 |
| Maltotriose [g/100 g DM] | 5.56 |
| Remainder [g/100 g DM] | 10.46 |

TABLE 6

| | WS 34/19 | |
|---|---|---|
| | (Isomalt | WS34/20 |
| Strawberry Hard Candies | Control) | (Control) |
| Mannite [g/100 g DM] | 0.31 | 0.17 |
| Sorbite [g/100 g DM] | 0.38 | 1.34 |
| Glucosyl glycerol [g/100 g DM] | 0.02 | 0.01 |
| Fructose [g/100 g DM] | 0.02 | 0.00 |
| Glucose [g/100 g DM] | 0.16 | 0.11 |
| Desoxydisaccharide alcohol [g/100 g DM] | 0.05 | 0.04 |
| 1,1 GPS [g/100 g DM] | 0.22 | 0.16 |
| GPI [g/100 g DM] | 0.07 | 0.06 |
| GPM [g/100 g DM] | 45.20 | 31.80 |
| GPS [g/100 g DM] | 49.30 | 34.70 |
| Total additional glucosylglucitols [g/100 g DM] | 0.19 | 0.56 |
| Palatinose [g/100 g DM] | 0.02 | 0.02 |
| Isomaltose [g/100 g DM] | 0.00 | 0.05 |
| Isomelezitose [g/100 g DM] | 0.00 | 0.44 |
| 6′-glucosyl-1,1 GPS [g/100 g DM] | 0.05 | 0.02 |
| 6′-glucosyl-1,1 GPM [g/100 g DM] | 0.21 | 0.11 |
| 6′-glucosyl-1,6 GPS [g/100 g DM] | 0.14 | 0.07 |
| 1-glucosyl-1,6 GPS [g/100 g DM] | 0.07 | 0.05 |
| 6-glucosyl-1,1 GPM [g/100 g DM] | 0.09 | 0.06 |
| Total additional DP-3H2 [g/100 g DM] | 0.77 | 0.30 |
| Maltitol [g/100 g DM] | 0.03 | 14.50 |
| Maltotriose [g/100 g DM] | 0.08 | 5.25 |
| Remainder [g/100 g DM] | 2.62 | 10.18 |

TABLE 7

| | WS34/26 |
|---|---|
| Strawberry Hard Candies | (Invention) |
| Mannite [g/100 g DM] | 0.29 |
| Sorbite [g/100 g DM] | 1.53 |
| Glucose [g/100 g DM] | 0.05 |
| Desoxydisaccharide alcohol [g/100 g DM] | 0.02 |
| 1,1 GPS [g/100 g DM] | 0.25 |
| GPI [g/100 g DM] | 0.11 |
| GPM [g/100 g DM] | 61.05 |
| GPS [g/100 g DM] | 6.22 |
| Total additional glucosylglucitols [g/100 g DM] | 0.47 |
| Isomaltose | 0.01 |
| Isomelezitose [g/100 g DM] | 0.16 |
| 6′-glucosyl-1,6 GPS [g/100 g DM] | 0.00 |
| 1-glucosyl-1,6 GPS [g/100 g DM] | 0.00 |
| 6-glucosyl-1,1 GPM [g/100 g DM] | 0.00 |
| Total additional DP-3H2 [g/100 g DM] | 0.18 |
| Maltitol [g/100 g DM] | 15.80 |
| Maltotriose [g/100 g DM] | 6.04 |
| Remainder [g/100 g DM] | 7.82 |

TABLE 8

| | MS 216/1 |
|---|---|
| Vitreous Body | (Control) |
| Glycerin [g/100 g DM] | 0.15 |
| Mannite [g/100 g DM] | 0.52 |
| Sorbite [g/100 g DM] | 0.26 |
| Glucosyl glycerin [g/100 g DM] | 0.04 |
| Glucose [g/100 g DM] | 0.23 |
| Desoxydisaccharide alcohol [g/100 g DM] | 0.09 |
| 1,1 GPS [g/100 g DM] | 0.14 |
| GPI [g/100 g DM] | 0.07 |
| GPM [g/100 g DM] | 68.70 |
| GPS [g/100 g DM] | 27.70 |
| Total additional glucosylglucitols [g/100 g DM] | 0.50 |
| 6′-glucosyl-1,1 GPS [g/100 g DM] | 0.04 |
| 6′-glucosyl-1,1 GPM [g/100 g DM] | 0.40 |
| 6′-glucosyl-1,6 GPS [g/100 g DM] | 0.11 |
| 1-glucosyl-1,6 GPS [g/100 g DM] | 0.05 |
| 6-glucosyl-1,1 GPM [g/100 g DM] | 0.09 |
| Total additional DP-3H2 [g/100 g DM] | 0.69 |
| Maltitol [g/100 g DM] | 0.06 |
| Maltotriose [g/100 g DM] | 0.04 |

TABLE 9

| | MS 216/5 |
|---|---|
| Vitreous Body | (Control) |
| Glycerin [g/100 g DM] | 0.09 |
| Mannite [g/100 g DM] | 0.21 |
| Sorbite [g/100 g DM] | 1.11 |
| Glucosyl glycerin [g/100 g DM] | 0.03 |
| Glucose [g/100 g DM] | 0.13 |
| Desoxydisaccharide alcohol [g/100 g DM] | 0.07 |
| 1,1 GPS [g/100 g DM] | 0.11 |
| GPI [g/100 g DM] | 0.06 |
| GPM [g/100 g DM] | 53.70 |
| GPS [g/100 g DM] | 16.70 |
| Total additional glucosylglucitols [g/100 g DM] | 0.58 |
| 6′-glucosyl-1,1 GPS [g/100 g DM] | 0.02 |
| 6′-glucosyl-1,1 GPM [g/100 g DM] | 0.04 |
| 6′-glucosyl-1,6 GPS [g/100 g DM] | 0.04 |
| 1-glucosyl-1,6 GPS [g/100 g DM] | 0.01 |
| 6-glucosyl-1,1 GPM [g/100 g DM] | 0.05 |
| Total additional DP-3H2 [g/100 g DM] | 0.51 |
| Maltitol [g/100 g DM] | 16.30 |
| Maltotriose [g/100 g DM] | 6.32 |
| Remainder [g/100 g DM] | 3.92 |

TABLE 10

| | MS 216/7 |
|---|---|
| Vitreous Body | (Invention) |
| Glycerin [g/100 g DM] | 0.09 |
| Mannite [g/100 g DM] | 0.87 |
| Sorbite [g/100 g DM] | 0.26 |
| Glucosyl glycerin [g/100 g DM] | 0.04 |
| Glucose [g/100 g DM] | 0.37 |
| Desoxydisaccharide alcohol [g/100 g DM] | 0.10 |
| 1,1 GPS [g/100 g DM] | 0.21 |
| GPI [g/100 g DM] | 0.14 |
| GPM [g/100 g DM] | 65.30 |
| GPS [g/100 g DM] | 26.20 |
| Total additional glucosyl-glucitols [g/100 g DM] | 0.64 |
| 6′-glucosyl-1,1 GPS [g/100 g DM] | 0.09 |
| 6′-glucosyl-1,1 GPM [g/100 g DM] | 0.77 |
| 6′-glucosyl-1,6 GPS [g/100 g DM] | 0.21 |
| 1-glucosyl-1,6 GPS [g/100 g DM] | 0.05 |
| 6-glucosyl-1,1 GPM [g/100 g DM] | 0.13 |
| Total additional DP-3H2 [g/100 g DM] | 1.35 |
| Maltitol [g/100 g DM] | 2.61 |
| Maltotriose [g/100 g DM] | 0.09 |
| Remainder [g/100 g DM] | 0.48 |

TABLE 11

| | MS 216/13 |
|---|---|
| Vitreous Body | (Invention) |
| Glycerin [g/100 g DM] | 0.07 |
| Mannite [g/100 g DM] | 0.03 |
| Sorbite [g/100 g DM] | 0.53 |
| Desoxydisaccharide alcohol [g/100 g DM] | 0.04 |
| 1,1 GPS [g/100 g DM] | 0.05 |
| GPI [g/100 g DM] | 0.03 |
| GPM [g/100 g DM] | 61.80 |
| GPS [g/100 g DM] | 9.03 |
| Total additional glucosylglucitols [g/100 g DM] | 0.20 |
| 6′-glucosyl-1,1 GPM [g/100 g DM] | 0.03 |
| 6′-glucosyl-1,6 GPS [g/100 g DM] | 0.01 |
| 1-glucosyl-1,6 GPS [g/100 g DM] | 0.02 |
| 6-glucosyl-1,1 GPM [g/100 g DM] | 0.04 |
| Total additional DP-3H2 [g/100 g DM] | 0.00 |
| Maltitol [g/100 g DM] | 15.80 |
| Maltotriose [g/100 g DM] | 0.06 |
| Remainder [g/100 g DM] | 12.26 |

TABLE 12

| | MS 216/15 |
|---|---|
| Cream Hardy Candies | (Control) |
| Glycerin [g/100 g DM] | 0.08 |
| Mannite [g/100 g DM] | 0.03 |
| Sorbite [g/100 g DM] | 0.05 |
| Glucosyl glycerin [g/100 g DM] | 0.09 |
| Desoxydisaccharide alcohol [g/100 g DM] | 0.03 |
| 1,1 GPS [g/100 g DM] | 0.17 |
| GPI [g/100 g DM] | 0.11 |
| GPM [g/100 g DM] | 65.00 |
| GPS [g/100 g DM] | 25.30 |
| Total additional glucosylglucitols [g/100 g DM] | 0.27 |
| 6′-glucosyl-1,1 GPM [g/100 g DM] | 0.03 |
| 6′-glucosyl-1,6 GPS [g/100 g DM] | 0.02 |
| 1-glucosyl-1,6 GPS [g/100 g DM] | 0.05 |
| 6-glucosyl-1,1 GPM [g/100 g DM] | 0.06 |
| Total additional DP-3H2 [g/100 g DM] | 0.22 |
| Maltitol [g/100 g DM] | 0.00 |
| Maltotriose [g/100 g DM] | 0.00 |
| Remainder [g/100 g DM] | 8.49 |

TABLE 13

| | MS 216/28 |
|---|---|
| Vitreous Body | (Invention) |
| Glycerin [g/100 g DM] | 0.80 |
| Mannite [g/100 g DM] | 0.04 |
| Sorbite [g/100 g DM] | 0.35 |
| Glucosyl glycerin [g/100 g DM] | 0.02 |
| Glucose [g/100 g DM] | 0.00 |
| Desoxydisaccharide alcohol [g/100 g DM] | 0.04 |
| 1,1 GPS [g/100 g DM] | 0.14 |
| GPI [g/100 g DM] | 0.03 |
| GPM [g/100 g DM] | 69.90 |
| GPS [g/100 g DM] | 21.60 |
| Total additional glucosylglucitols [g/100 g DM] | 0.48 |
| 6′-glucosyl-1,1 GPS [g/100 g DM] | 0.00 |
| 6′-glucosyl-1,1 GPM [g/100 g DM] | 0.03 |
| 6′-glucosyl-1,6 GPS [g/100 g DM] | 0.01 |
| 1-glucosyl-1,6 GPS [g/100 g DM] | 0.02 |
| 6-glucosyl-1,1 GPM [g/100 g DM] | 0.06 |
| Total additional DP-3H2 [g/100 g DM] | 0.02 |
| Maltitol [g/100 g DM] | 5.86 |
| Maltotriose [g/100 g DM] | 2.21 |

TABLE 14

| | MS 216/29 |
|---|---|
| Vitreous Body | (Control) |
| Glycerin [g/100 g DM] | 0.12 |
| Mannite [g/100 g DM] | 0.02 |
| Sorbite [g/100 g DM] | 0.32 |
| Glucosyl glycerin [g/100 g DM] | 0.02 |
| Desoxydisaccharide alcohol [g/100 g DM] | 0.04 |
| 1,1 GPS [g/100 g DM] | 0.10 |
| GPI [g/100 g DM] | 0.02 |
| GPM [g/100 g DM] | 79.10 |
| GPS [g/100 g DM] | 12.60 |
| Total additional glucosylglucitols [g/100 g DM] | 0.30 |
| 6′-glucosyl-1,1 GPM [g/100 g DM] | 0.02 |
| 6′-glucosyl-1,6 GPS [g/100 g DM] | 0.03 |
| 1-glucosyl-1,6 GPS [g/100 g DM] | 0.01 |
| 6-glucosyl-1,1 GPM [g/100 g DM] | 0.05 |
| Total additional DP-3H2 [g/100 g DM] | 0.01 |
| Maltitol [g/100 g DM] | 5.58 |
| Maltotriose [g/100 g DM] | 2.09 |

TABLE 15

| | MS 221/1 |
|---|---|
| | (Isomalt |
| Strawberry Hard Candy | Control) |
| Mannite [g/100 g DM] | 0.07 |
| Sorbite [g/100 g DM] | 0.15 |
| Glucosyl glycerin [g/100 g DM] | 0.04 |
| Glucose | 0.05 |
| Desoxydisaccharide alcohol [g/100 g DM] | 0.13 |
| 1,1 GPS [g/100 g DM] | 0.36 |
| GPI [g/100 g DM] | 0.26 |
| GPM [g/100 g DM] | 47.00 |
| GPS [g/100 g DM] | 52.30 |
| Total additional glucosylglucitols [g/100 g DM] | 0.18 |
| Palatinate | 0.03 |
| 6′-glucosyl-1,1 GPM [g/100 g DM] | 0.02 |
| 6′-glucosyl-1,6 GPS [g/100 g DM] | 0.03 |
| 1-glucosyl-1,6 GPS [g/100 g DM] | 0.05 |
| 6-glucosyl-1,1 GPM [g/100 g DM] | 0.06 |
| Total additional DP-3H2 [g/100 g DM] | 0.14 |
| Maltitol [g/100 g DM] | 0.05 |
| Maltotriose [g/100 g DM] | 0.00 |
| Remainder | 0.00 |

TABLE 16

| | MS 222/4 |
|---|---|
| Vitreous Body | (Control) |
| Mannite [g/100 g DM] | 0.04 |
| Sorbite [g/100 g DM] | 0.22 |
| Glucose [g/100 g DM] | 0.02 |
| Desoxydisaccharide alcohol [g/100 g DM] | 0.06 |
| 1,1 GPS [g/100 g DM] | 0.15 |
| GPI [g/100 g DM] | 0.18 |
| GPM [g/100 g DM] | 73.50 |
| GPS [g/100 g DM] | 23.40 |
| Total additional glucosylglucitols [g/100 g DM] | 0.16 |
| 6′-glucosyl-1,1 GPM [g/100 g DM] | 0.03 |
| 6′-glucosyl-1,6 GPS [g/100 g DM] | 0.03 |
| 1-glucosyl-1,6 GPS [g/100 g DM] | 0.03 |
| 6-glucosyl-1,1 GPM [g/100 g DM] | 0.05 |
| Total additional DP-3H2 [g/100 g DM] | 0.03 |
| Maltitol [g/100 g DM] | 2.279 |
| Maltotriose [g/100 g DM] | 1.05 |
| Remainder [g/100 g DM] | 0.00 |

TABLE 17

| | MS 222/7 |
|---|---|
| Vitreous Body | (Control) |
| Mannite [g/100 g DM] | 0.03 |
| Sorbite [g/100 g DM] | 0.38 |
| Glucose [g/100 g DM] | 0.01 |
| Desoxydisaccharide alcohol [g/100 g DM] | 0.04 |
| 1,1 GPS [g/100 g DM] | 0.09 |
| GPI [g/100 g DM] | 0.11 |
| GPM [g/100 g DM] | 76.40 |
| GPS [g/100 g DM] | 14.60 |
| Total additional glucosylglucitols [g/100 g DM] | 0.14 |
| Total additional DP-3H2 [g/100 g DM] | 0.00 |
| Maltitol [g/100 g DM] | 5.97 |
| Maltotriose [g/100 g DM] | 2.28 |

TABLE 18

| | MS 222/10 |
|---|---|
| Strawberry Hard Candies | (Invention) |
| Mannite [g/100 g DM] | 0.1 |
| Sorbite [g/100 g DM] | 0.39 |
| Glucose [g/100 g DM] | 0.04 |
| Desoxydisaccharide alcohol [g/100 g DM] | 0.04 |
| 1,1 GPS [g/100 g DM] | 0.14 |
| GPI [g/100 g DM] | 0.03 |
| GPM [g/100 g DM] | 68.80 |
| GPS [g/100 g DM] | 22.40 |
| Total additional glucosylglucitols [g/100 g DM] | 0.30 |
| 6′-glucosyl-1,1 GPM [g/100 g DM] | 0.03 |
| 6′-glucosyl-1,6 GPS [g/100 g DM] | 0.02 |
| 1-glucosyl-1,6 GPS [g/100 g DM] | 0.02 |
| 6-glucosyl-1,1 GPM [g/100 g DM] | 0.06 |
| Total additional DP-3H2 [g/100 g DM] | 0.17 |
| Maltitol [g/100 g DM] | 5.67 |
| Maltotriose [g/100 g DM] | 2.19 |
| Remainder [g/100 g DM] | 0.00 |

The cream hard candies MS 216/15, in addition to the previously listed recipe ingredients, also contained cream (8.35 g/100 g), butterfat (3.93 g/100 g), salt 0.45 g/100 g), lecithin (Metarin P IP) (0.07 g/110 g), aspartame (0.05 f/100 g), acesulfame K (0.05 g/100 g) and vanilla flavoring (0.10 g/100 g).

The strawberry hard candies MS 222/10, in addition to the previously listed recipe ingredients, also contained strawberry flavoring (11 48 71 01 90 Silesia) (0.30 g/100 g), DL malic acid (0.90 g/100 g) and Vegex Carmine 20 ALB (22 467 290 CHR Hansen) (0.10 g/100 g).

The water content of the hard candies was adjusted to approximately 1.5%.

The cream hard candies WS 34/10, 34/11 and 34/17, in addition to the previously listed recipe ingredients, also contained cream (8.35 g/100 g), butterfat (3.93 g/100 g), salt (0.45 g/100 g), lecithin (Topcithin 300) (0.07 g/100 g), aspartame (0.05 g/100 g), acesulfame K (0.05 g/100 g) and vanilla flavoring 0.10 g/100 g).

The strawberry hard candies WS 34/19, WS 34/20 and WS 34/26, in addition to the previously listed recipe ingredients, also contained DL malic acid (0.90 g/100 g), strawberry flavoring (11 48 71 01 90 Silesia) (0.30 g/100 g) and Vegex Carmine 20 ALB (22 46 290 CHR Hansen) (0.10 g/100 g).

Examples of recipes in accordance with the invention are identified as “Invention.” Recipes which have conventional isomalt as the primary ingredient of the vitreous body (WS 34/10, WS 34/19 and MS 222/1) were denoted as isomalt control and are not in accordance with the invention. Recipes which diverge from the teaching in accordance with the invention are denoted as “Control.”

B) Manufacture of the Vitreous Body/Hard Candies

The vitreous bodies were manufactured as follows. The sweetening agent mixture given in each case is heated with water in the batch cooker to 155-160° C. and exposed to a total vacuum for about 1 to 1.5 minutes (addition of patent blue as a dye in order to be able analyze crystallization better, that means to be able perceive it better visually). The mass is cooled on a cooling table while being constantly folded. The cooled, plastically deformable mass is molded into candy and cooled down further to room temperature. The aforementioned recipe can also be processed into candy on a continuous line (for example, Bosch, Klöckner-Hänsel) or without adding water by melt extrusion. In accordance with the invention, both stamped and cast candies can be manufactured.

The hard candies were manufactured as follows. The sweetening agent mixture, to which a mixture of up to 4% (dry material) consisting of natural fruit concentrate, intense sweeteners, flavorings and dyes is added, is boiled with water on a continuous cooking unit to 155-160° C. To evaporate the water, the mass is exposed to total vacuum for up to five minutes. The mass which has cooled to 124 to 146° C. as a result of the evacuation is folded on a cooling belt, further cooled under supervision to a plastically deformable mass and molded on a molding line. Then the hard candies are cooled further in a cooling tunnel. The aforementioned recipe can also be processed into candies in batches or without adding water using melt extrusion. In accordance with the invention, both molded and poured hard candies can be manufactured.

### EXAMPLE 2

### Storage Characteristics and Taste Sensation

a) The vitreous bodies or hard candies from Example 1 were stored in open Petri dishes at 25° C. and a relative humidity of 80%. The water absorption of the vitreous bodies/hard candies was determined daily by means of a scale, the appearance of the vitreous bodies evaluated and they were photographed (FIGS. 1 to 7). In this way recrystallization tendencies could be established unambiguously.

The storage stability of the hard candies can be seen from the hard candies shown in FIGS. 1 to 7 after 3-days stress storage. A comparatively poor storage quality is documented by a whitish coloring of the hard candies, specifically opacity which indicates recrystallization. Poor storage quality also reveals itself through the formation of folds and furrows on the surface as well as the formation of greasiness or stickiness and melting of the surface of a hard candy.

FIG. 1 shows the onset of turbidity and a crystalline surface forming in the isomalt control MS 222/1 and the control hard candy MS 216/1. MS 222/4 appears to be storage-stable, but in spite of a non-crystalline surface it has poor sensory qualities (compare b) following). In contrast, the hard candy MS 216/28 in accordance with the invention is characterized by a largely unchanged surface quality, meaning no melting, no stickiness or recrystallization. Although the samples MS 222/1 MS 216/1 were evaluated as attractive to the senses (compare b) following), their storage stability has deteriorated in comparison to the hard candies in accordance with the invention.

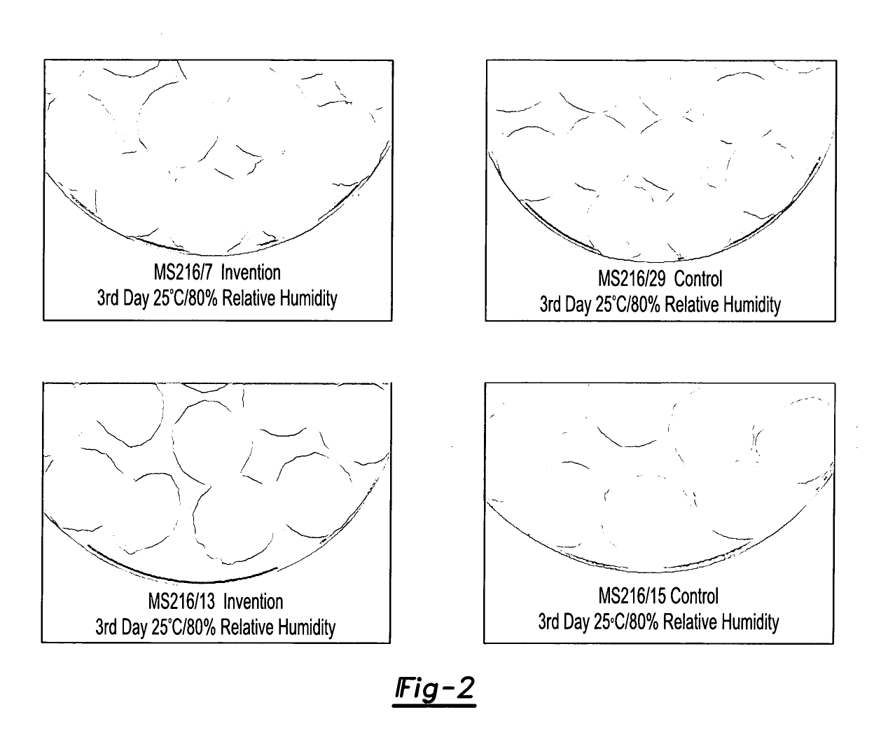

From FIG. 2 it can be seen that the hard candies MS 216/7 and MS 216/13 in accordance with the invention show a high degree of storage stability according to the above criteria, while the control MS 216/15 already shows strong tendencies to recrystallization and the control MS 216/29, while not showing any recrystallization tendencies, is organoleptically unimpressive (compare paragraph b) following).

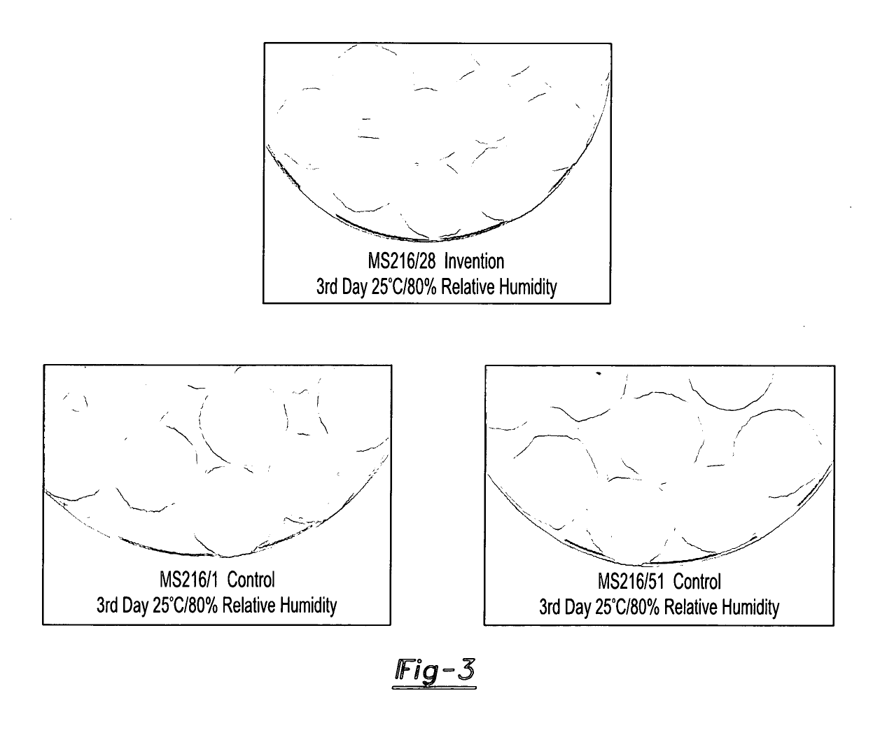

From FIG. 3 it can be seen that the hard candy MS 216/28 in accordance with the invention shows good storage stability, while the hard candies MS 216/1 and MS 216/5 show clear structural changes on the surface and have comparatively low storage stability.

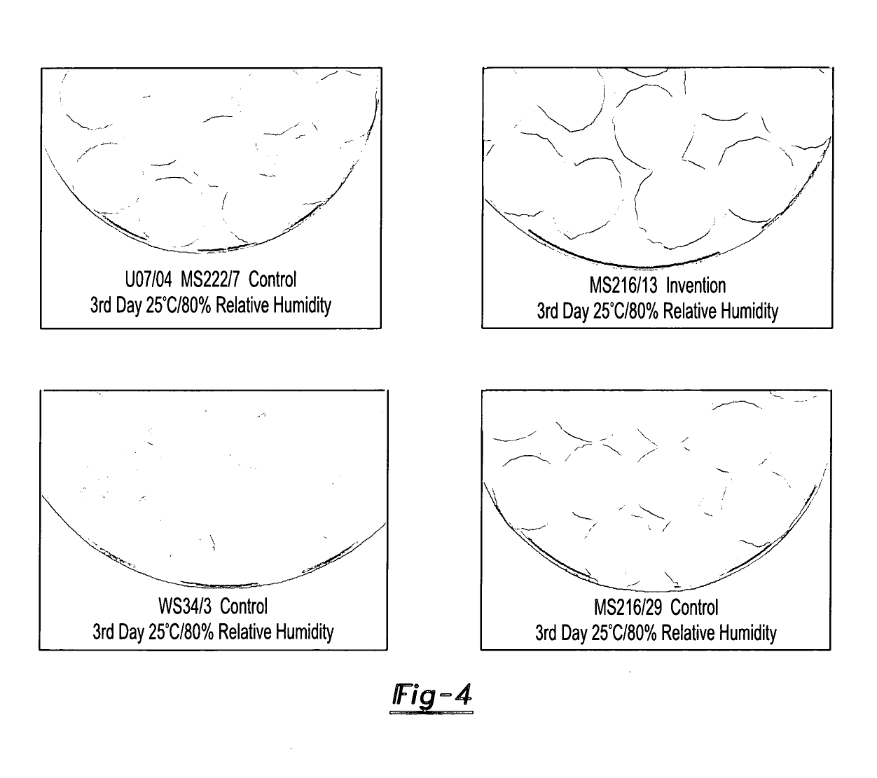

From FIG. 4 it can be seen that the hard candies MS 216/13 show a high degree of storage stability, while the control WS 34/3 shows marked evidence of recrystallization. The hard candies MS 222/7 and MS 216/29 are characterized by unsatisfactory sensory characteristics, as becomes clear from the following section b).

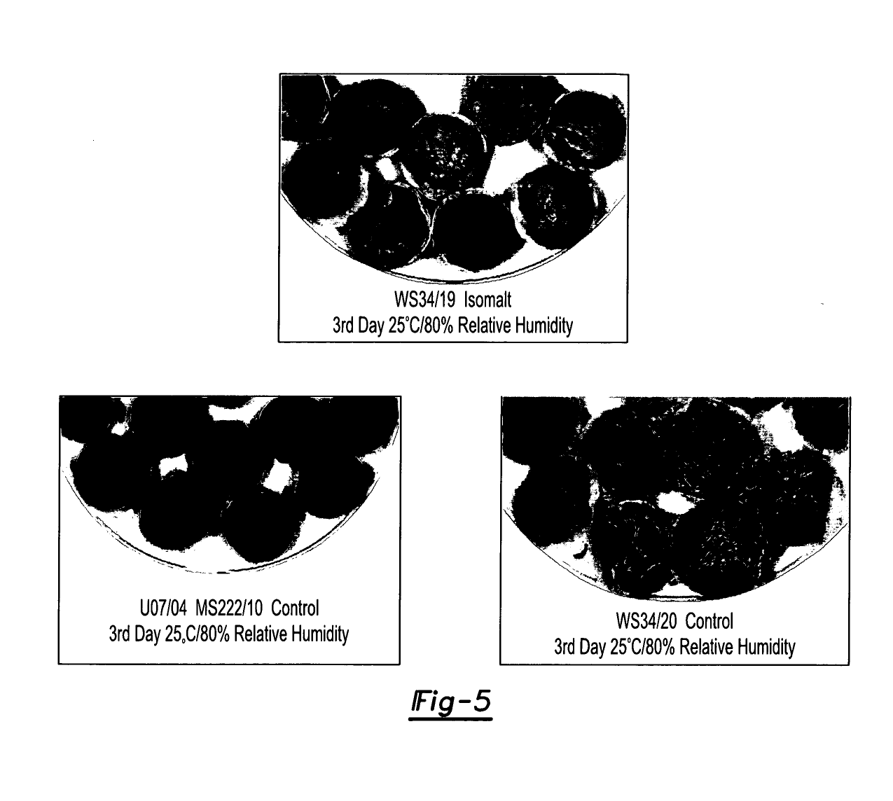

From FIG. 5 it can be seen that the hard candy MS 222/10 in accordance with the invention demonstrates good storage ability, while the isomalt comparison hard candy WS 34/19 shows clear structural changes, which also applies to the hard candy WS 34/20.

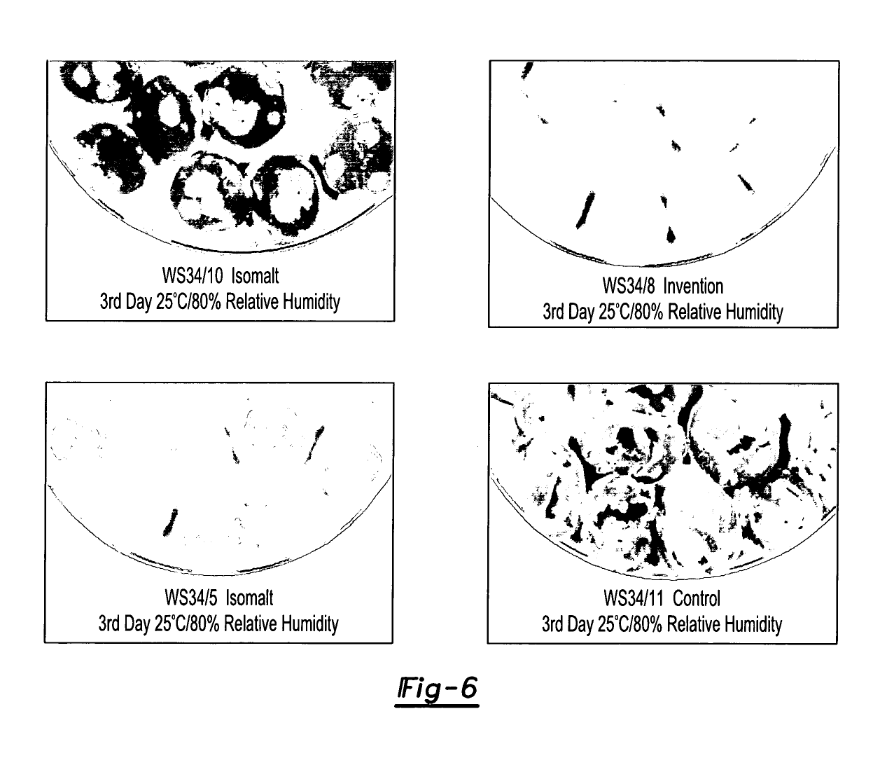

From FIG. 6 it can be seen that the hard candy WS 34/8 in accordance with the invention has good storage characteristics, while the isomalt control WS 34/10, as well the controls WS 34/5 and WS 34/11 show very poor storage stability.

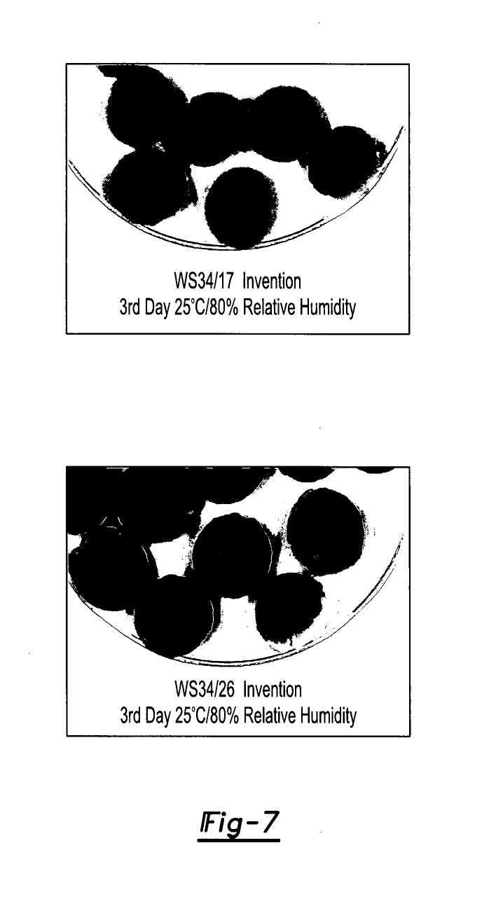

From FIG. 7 it can be seen that the hard candies WS 34/17 and WS 34/26 in accordance with the invention have good storage stability.

In general, and beyond this example, the teaching can therefore be maintained that the hard candies in accordance with the invention show a reduced tendency to recrystallization and increased storage stability in comparison to isomalt hard candies.

b) The sensory characteristics of the hard candies in accordance with the invention were evaluated as part of the present invention specifically on the basis of freshly manufactured hard candies, where the hard candies were each evaluated by at least 5 testers independently of each other and classified on a sensory perception scale using the levels 1 (smooth) to 3 (rough) (FIGS. 8 to 13). Improved sensory perception exists specifically when the hard candies, compared with comparable candy, specifically hard candies with a higher 1,1 GPM content, for example above 70% by weight (relative to dry material of the total weight) have a lesser degree of roughness and/or a lesser degree of greasiness and/or stickiness, where the roughness is both initial roughness which a hard candy has before it is consumed as well roughness forming while it is being consumed in the mouth. Isomalt hard candies have a low degree of roughness but are distinguished by comparatively poor storage stability, as is clear from paragraph a) preceding.

From the sensory tests (FIGS. 8 to 13), it can be seen that the hard candies with the designations MS 216/1, WS 34/5, MS 216/5, MS 216/7, MS 216/13, WS 34/11, WS 34/17, WS 34/26, MS 222/1 (isomalt control), MS 34/10 (isomalt control), MS 216/28, MS 222/10, WS 34/8, WS 34/19 (isomalt hard candy) and WS 34/20 have very little roughness and are experienced as sensorily attractive. The hard candies with the designations MS 216/29, MS 216/15, MS 222/4, MS 222/7 and WS 34/3 are distinguished by an excessive degree of roughness, both compared with isomalt hard candies and when compared with hard candies in accordance with the invention. In particular the hard candies MS 216/29, MS 222/7 and MS 222/4 show no recrystallization characteristics in the storage test, but are distinguished in the sensory test by a formation of roughness that becomes unpleasantly noticeable during consumption.

c) Results

The table below lists the vitreous bodies/hard candies that, based on their storage stability or their sensory characteristics, did not show any improvement vis-a-vis comparable hard candies/vitreous bodies of pure isomalt (isomalt hard candies (approximately equimolar mixture of 1,1 GPM and 1,6 GPS): WS 34/10, WS 34/19 and MS 222/1).

TABLE 19

| | | | | | | No |
|---|---|---|---|---|---|---|
| | Water | GPM | Maltite | Sorbite | Worse | improved |
| | content | [g/100 g | [g/100 g | [g/100 g | sensory | storage |
| Sample | [g/100 g] | DM] | DM] | DM] | experience | stability |
| MS 216/29 | 1.6 | 79.10 | 5.58 | 0.32 | xxxxx | |
| WS 34/5 | 1.4 | 42.00 | 26.60 | 1.79 | | xxxxx |
| MS 222/7 | 1.5 | 76.40 | 5.97 | 0.38 | xxxxx | |
| MS 222/4 | 1.5 | 73.50 | 2.79 | 0.22 | xxxxx | |
| MS 216/5 | 1.4 | 53.70 | 16.30 | 1.10 | | xxxxx |
| MS 216/1 | 1.5 | 68.70 | 0.06 | 0.26 | | xxxxx |
| WS 34/20 | 0.81 | 31.80 | 14.50 | 1.34 | | xxxxx |
| WS 34/11 | 1.1 | 29.80 | 15.0 | 0.89 | | xxxxx |
| MS 216/15 | 1.2 | 65.00 | 0.00 | 0.05 | xxxxx | xxxxx |
| WS 34/3 | 1.4 | 84.90 | 0.00 | 0.03 | xxxxx | xxxxx |

It is shown then that satisfactory hard candies can only be achieved if both an appealing taste sensation as well as high storage stability can be attained at the same time. Hard candies with sensory properties may have only low storage stability, while hard candies with good storage stability may demonstrate poor sensory properties and are therefore not experienced by consumers as attractive.

In particular the hard candies with the numbers MS 222/4, MS 222/7 and MS 216/29, which are distinguished by a comparatively high 1,1 GPM content compared with isomalt, do not demonstrate any recrystallization phenomena in the storage test adversely affecting storage stability, but in the sensory test they give an effect of roughness since roughness arises or is created during consumption of the hard candies, probably from the formation of 1,1 GPM crystals. The samples mentioned of hard candies MS 222/4, MS 222/7 and MS 216/29 show that in spite of the absence of recrystallization processes during the stress storage nevertheless roughness is experience during consumption by the consumer, which proves to be disadvantageous for the existence of the product.

The table below lists the vitreous bodies and hard candies in accordance with the invention whose storage stability vis-à-vis comparable vitreous bodies or comparable hard candies of pure isomalt ST (WS 34/10, WS 34/19 and MS 222/1) was improved and which at the same time were judged in their sensory characteristics as approximately as good as hard candies of isomalt, or better than hard candies with a 1,1 GPM content above 70% by weight.

TABLE 20

| | | Water | | | |
|---|---|---|---|---|---|
| | | content | GPM | Maltite | Sorbite |
| Sample | Recipe | [g/100 g] | [g/100 g] | [g/100 g] | [g/100 g] |
| MS 216/7 | Vitreous body | 1.4 | 65.30 | 2.61 | o.26 |
| MS 216/28 | Vitreous body | 1.6 | 69.90 | 5.86 | 0.35 |
| MS 222/10 | Strawberry hard | 1.7 | 68.80 | 5.67 | 0.39 |
| | candy | | | | |
| MS 216/13 | Vitreous body | 1.5 | 61.80 | 15.80 | 0.53 |
| WS 34/8 | Vitreous body | 1.3 | 61.80 | 16.60 | 1.41 |
| WS 34/26 | Strawberry hard | 1.2 | 61.05 | 15.80 | 1.53 |
| | candy | | | | |
| WS 34/17 | Cream hard | 1.2 | 61.00 | 14.60 | 1.15 |
| | candy | | | | |

1-17. (canceled)

18. A hard candy composition comprising 1,1 GPM (1-O-α-D-glucopyranosyl-D-mannitol) at a quantity represented by X, wherein X is about 61 to about 70% by weight of the total candy composition on a dry basis; maltitol at a quantity represented by Y, wherein Y is from about 2.5 to about 17% by weight of the total candy composition on a dry basis; and sorbitol at a quantity represented by S, wherein
S=c+(b×X)+(a×X×Y)
where a=0.0016 to 0.0005, b=−0.0139 to 0.0019, c=0.9 to −0.19, and S is expressed as a weight % of the total candy composition on a dry basis.

19. The hard candy composition according to claim 18, wherein X is about 62 to about 68% by weight of the total candy composition on a dry basis.

20. The hard candy composition according to claim 18, wherein S is about 0.1 to about 1.6% by weight of the total candy composition on a dry basis.

21. The hard candy composition according to claim 18, wherein S is about 0.2 to about 1.6% by weight of the total candy composition on a dry basis.

22. The hard candy composition according to claim 18, wherein S is about 0.4 to about 1% by weight of the total candy composition on a dry basis.

23. The hard candy composition according to claim 18, further comprising 1,6 GPS (6-O-α-D-glucopyranosyl-D-sorbitol) at about 5 to about 36% by weight of the total hard candy composition on a dry basis.

24. The hard candy composition according to claim 23, wherein Y is about 5 to about 16% by weight of the total candy composition on a dry basis.

25. The hard candy composition according to claim 23, further comprising water at less than or equal to about 4% by weight of the total candy composition.

26. The hard candy composition according to claim 23, further comprising water at less than or equal to about 2% by weight of the total candy composition.

27. The hard candy composition according to claim 23, further comprising maltotriose at less than or equal to about 8% by weight of the total candy composition on a dry basis.

28. The hard candy composition according to claim 27, wherein said maltotriose is about 3 to about 8% by weight of the total candy composition on a dry basis.

29. A hard candy formed of the hard candy composition according to claim 18.

30. The hard candy according to claim 29, wherein said hard candy is selected from a filled or unfilled solid.

31. The hard candy according to claim 29, wherein said hard candy is an unfilled candy that further comprises a filling selected from a liquid filling or a solid filling.

32. A hard candy according to claim 29, wherein the hard candy composition forms the top of the hard candy.

33. The hard candy composition according to claim 18, further comprising at least one component selected from the group consisting of: sweetening agents, fillers, flavoring agents, dyes, an active ingredient, food-compatible acids, fat substitutes, fat, dairy products, mineral salts, emulsifiers, and mixtures thereof, wherein said at least one component is present at a total quantity of about 1 to about 10% by weight of the total candy composition on a dry basis.

34. The hard candy composition according to claim 18, further comprising at least one sweetening agent selected from the group consisting of 1,6 GPS (6-O-α-D-glucopyranosyl-D-sorbitol); 1,1-GPS (1-O-α-D-glucopyranosyl-D-sorbitol), maltotriose, mannitol, higher polyols, hydrogenated oligosaccharides, non-hydrogenated oligosaccharides, and mixtures thereof, wherein said at least one sweetening agent is present at about 5% to about 36% by weight of the total candy composition on a dry basis.

35. A method for manufacturing a hard candy, the method comprising:
boiling an aqueous solution or suspension of a mixture comprising a candy composition by applying heat at temperatures of about 145° C. to about 170° C., wherein said candy composition comprises 1,1 GPM (1-O-α-D-glucopyranosyl-D-mannitol) at a quantity represented by X, wherein X is about 61 to about 70% by weight of the total candy composition on a dry basis; maltitol at a quantity represented by Y, wherein Y is about 2.5 to about 17% by weight of the total candy composition on a dry basis; and sorbitol at a quantity expressed by S, wherein S=c+(b×X)+(a×X×Y), a=0.0016 to 0.0005, b=−0.0139 to 0.0019, c=0.9 to −0.19, and S is expressed as a weight % of the total candy composition on a dry basis; and
evaporating, cooling, and shaping said boiled mixture, wherein a hard candy is obtained.

36. A method for manufacturing a hard candy, the method comprising:
melt extruding a mixture comprising a candy composition by applying heat at temperatures of about 145° C. to about 170° C., wherein said candy composition comprises 1,1 GPM (1-O-α-D-glucopyranosyl-D-mannitol) at a quantity represented by X, wherein X is about 61 to about 70% by weight of the total candy composition on a dry basis; maltitol at a quantity represented by Y, wherein Y is about 2.5 to about 17% by weight of the total candy composition on a dry basis; and sorbitol at a quantity expressed by S, wherein S=c+(b×X)+(a×X×Y), where a=0.0016 to 0.0005, b=−0.0139 to 0.0019, c=0.9 to −0.19, and S is expressed as a weight % of the total candy composition on a dry basis; and
cooling and shaping the melt extruded mixture to form a hard candy.
